(19) United States
(12) Patent Application Publication
(10) Pub. No.: US 2025/0304780 A1
(43) Pub. Date: Oct. 2, 2025

(54) PROCESS FOR PREPARING HETEROPHASIC POLYPROPYLENE COMPOSITION

(71) Applicant: SABIC GLOBAL TECHNOLOGIES B.V., Bergen op Zoom (NL)

(72) Inventors: Désirée Marie Louise SEEGERS, Maastricht (NL); Sarah VAN MIERLOO, Opglabbeek (BE); Aaron CANCELAS, Valladolid (ES); Martin Alexander ZUIDEVELD, Kelmis (BE); Henrica Norberta, Alberta, Maria STEENBAKKERS-MENTING, Susteren (NL)

(21) Appl. No.: 18/864,391

(22) PCT Filed: May 5, 2023
(86) PCT No.: PCT/EP2023/061895

§ 371 Date: Nov. 8, 2024

(30) Foreign Application Priority Data
May 13, 2022 (EP) 22173300.9

(51) Int. Cl. C08L 23/12

(52) U.S. Cl. CPC C08L 23/12; C08L 2205/025; C08L 2207/02; C08L 2314/02

(57) ABSTRACT

A process for the preparation of a polypropylene composition comprising a heterophasic propylene copolymer
wherein the heterophasic propylene copolymer consists of:
   a propylene homopolymer matrix in an amount from 71 to 92 wt %, based on the heterophasic propylene copolymer and
   an ethylene-propylene copolymer in an amount from 8 to 29 wt %, based on the heterophasic propylene copolymer,
   wherein the amount of units derived from ethylene based on the ethylene-propylene copolymer is between 40 to 60 wt %, and
wherein the polypropylene composition has
   a melt flow rate from 0.5 to 120 dg/min as determined according to ISO1133:2011 using 2.16 kg at 230° C.,
wherein the heterophasic propylene copolymer is produced in a sequential multi-reactor polymerization process in the presence of a catalyst in a gas phase to obtain the heterophasic propylene copolymer, wherein said catalyst comprises a procatalyst, a co-catalyst and optionally an external electron donor.

### TECHNICAL FIELD

The present invention relates to a process for the preparation of a heterophasic polypropylene composition.

Further, the present invention is also directed to an article comprising the inventive polypropylene composition, preferably to an article wherein the article is prepared by injection molding and/or wherein the article is a household article, a packaging article, a healthcare article or an automotive interior article. Further, the invention relates to the use of said polypropylene composition as well as to a process for the preparation of said article.

### BACKGROUND

Polymers, like polypropylene, are increasingly used in different demanding applications. At the same time, there is a continuous search for tailored polymers which meet the requirements of these applications. The demands can be challenging, since many polymer properties are directly or indirectly interrelated, i.e. improving a specific property can only be accomplished on the expense of another property. An example of properties in polypropylene that are interrelated are impact strength and stiffness.

There is a need in the art for a process for the preparation of a polypropylene composition comprising a heterophasic propylene copolymer having a high stiffness with a high catalyst yield.

### SUMMARY

It is therefore an object of the present invention to provide a process for the preparation of a polypropylene composition comprising a heterophasic propylene copolymer having a high stiffness with a high catalyst yield.

This object is achieved by a process for the preparation of a polypropylene composition comprising a heterophasic propylene copolymer, wherein the heterophasic propylene copolymer consists of:
a propylene homopolymer matrix in an amount from 71 to 92 wt %, preferably from 78 to 89 wt %, more preferably from 83 to 87 wt %, based on the heterophasic propylene copolymer and
an ethylene-propylene copolymer in an amount from 8 to 29 wt %, preferably from 11 to 22 wt %, more preferably 13 to 17 wt %, based on the heterophasic propylene copolymer,
wherein the amount of units derived from ethylene based on the ethylene-propylene copolymer is between 40 to 60 wt %, preferably 42 to 55 wt %, more preferably 43 to 51 wt %, and
wherein the polypropylene composition has
   a melt flow rate from 0.5 to 120, preferably 0.5 to 95, more preferably 0.5 to 85, even more preferably 0.5 to 80 dg/min as determined according to ISO1133:2011 using 2.16 kg at 230° C., and
wherein the heterophasic propylene copolymer is produced in a sequential multi-reactor polymerization process in the presence of a catalyst in a gas phase to obtain the heterophasic propylene copolymer, wherein said catalyst comprises a procatalyst, a co-catalyst and optionally an external electron donor, wherein the procatalyst is obtainable by a process comprising the steps of:
contacting a magnesium-containing support with a halogen-containing titanium compound, and an internal electron donor according to Formula I:

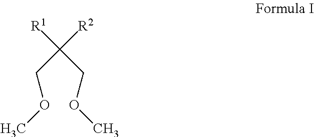

wherein R¹ is a secondary alkyl group and R² is a non-secondary alkyl group having at least 5 carbon atoms, preferably R² is a non-secondary alkyl group having at least 5 carbon atoms and being branched at the 3-position or further positions, said procatalyst is prepared according to the following steps:
   i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
   ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
   iii) contacting the first or second intermediate reaction product, obtained respectively in step i) or ii), with a halogen-containing Ti-compound and said compound represented Formula I, as the internal electron donor.

The invention further provides the polypropylene composition obtainable by or obtained by the process according to the invention.

The invention further provides a polypropylene composition comprising a heterophasic propylene copolymer, wherein the heterophasic propylene copolymer consists of:
a propylene homopolymer matrix in an amount from 71 to 92 wt %, preferably from 78 to 89 wt %, more preferably from 83 to 87 wt %, based on the heterophasic propylene copolymer and
an ethylene-propylene copolymer in an amount from 8 to 29 wt %, preferably from 11 to 22 wt %, more preferably 13 to 17 wt %, based on the heterophasic propylene copolymer,
wherein the amount of units derived from ethylene based on the ethylene-propylene copolymer is between 40 to 60 wt %, preferably 42 to 55 wt %, more preferably 43 to 51 wt %, and
wherein the polypropylene composition has
   a melt flow rate from 0.5 to 120, preferably 0.5 to 95, more preferably 0.5 to 85, even more preferably 0.5 to 80 dg/min as determined according to ISO1133:2011 using 2.16 kg at 230° C.,

According to the invention, it was surprisingly found that the use of a specific catalyst in the process for the preparation of a heterophasic propylene copolymer results in a combination of a high catalyst yield and a high stiffness of the composition (resulting from a high stiffness of the homopolymer matrix of the heterophasic propylene copolymer).

### DESCRIPTION OF EMBODIMENTS

### Heterophasic Propylene Copolymer

The polypropylene composition according to the invention comprises a heterophasic propylene copolymer. The heterophasic propylene copolymer consists of:
a propylene homopolymer matrix in an amount from 71 to 92 wt %, preferably from 78 to 89 wt %, more preferably from 83 to 87 wt %, based on the heterophasic propylene copolymer and
an ethylene-propylene copolymer in an amount from 8 to 29 wt %, preferably from 11 to 22 wt %, more preferably 13 to 17 wt %, based on the heterophasic propylene copolymer,
the amount of units derived from ethylene based on the ethylene-propylene copolymer is between 40 to 60 wt %, preferably 42 to 55 wt %, more preferably 43 to 51 wt %, and

The amount of propylene homopolymer matrix and ethylene-propylene copolymer is 100 wt % based on the heterophasic propylene copolymer. The amount of the ethylene-propylene copolymer with respect to the heterophasic propylene copolymer (herein sometimes referred as RC) and the amount of units derived from ethylene with respect to the ethylene-propylene copolymer in the heterophasic propylene copolymer (herein sometimes referred as RCC2) can be determined by ¹³C-NMR spectroscopy.

Preferably, the heterophasic propylene copolymer has a CXS in the range from 8 to 29 wt %, preferably from 10 to 28, more preferably 11 to 22 wt %, even more preferably from 11 to 16 wt %, wherein the CXS is measured by the method described in the section “CRYSTEX method for heterophasic propylene copolymer” of the Measurement methods section of the present application.

Preferably, the heterophasic propylene copolymer has a melt flow rate (MFR) in the range from 0.50 to 110 dg/min, wherein the melt flow rate is determined using ISO1133-1:2011 using 2.16 kg at 230° C.

In some preferred embodiments, the MFR of the heterophasic propylene copolymer determined using ISO1133-1:2011 using 2.16 kg at 230° C. is 0.50 to 30 dg/min.

In some other preferred embodiments, the MFR of the heterophasic propylene copolymer determined using ISO1133-1:2011 using 2.16 kg at 230° C. is 30 to 110 dg/min.

In some embodiments, the heterophasic propylene copolymer within the polypropylene composition is prepared by visbreaking an intermediate heterophasic propylene copolymer having an initial melt flow rate (MFRinitial) from 0.5 to 50 dg/min, preferably 0.5 to 40 dg/min, more preferably 4.0 to 40 dg/min as determined according to ISO1133-1:2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 0.5 to 120, preferably 0.5 to 80, more preferably 5.0 to 80, even more preferably 3 to 45 dg/min as determined according to ISO1133-1:2011 using 2.16 kg at 230° C. is obtained.

The term “visbreaking” is well known in the field of the invention. For example methods of visbreaking polypropylene have been disclosed in U.S. Pat. No. 4,282,076 and EP 0063654.

Several different types of chemical reactions which are well known can be employed for visbreaking propylene polymers. An example is thermal pyrolysis, which is accomplished by exposing a polymer to high temperatures, e.g., in an extruder at 350° C. or higher. Another approach is exposure to powerful oxidizing agents. A further approach is exposure to ionizing radiation. It is preferred however that visbreaking is carried out using a peroxide. Such materials, at elevated temperatures, initiate a free radical chain reaction resulting in beta-scission of the polypropylene molecules. The visbreaking may be carried out directly after polymerisation and removal of unreacted monomer and before pelletisation (during extrusion in an extruder wherein shifting of the intermediate heterophasic propylene copolymer occurs). However, the invention is not limited to such an embodiment and visbreaking may also be carried out on already pelletised polypropylene, which polypropylene generally contains stabilisers to prevent degradation.

Examples of suitable peroxides include organic peroxides having a decomposition half-life of less than 1 minute at the average process temperature during the visbreaking step. Suitable organic peroxides include but are not limited to dialkyl peroxides, e.g. dicumyl peroxides, peroxyketals, peroxycarbonates, diacyl peroxides, peroxyesters and peroxydicarbonates. Specific examples of these include benzoyl peroxide, dichlorobenzoyi peroxide, dicumyl peroxide, di-tert-butyl peroxide, 2,5-dimethyl-2,5-di(peroxybenzoato)-3-hexene, 1,4-bis(tert-butylperoxyisopropyl)benzene, lauroyl peroxide, tert-butyl peracetate, a,a′-bis(tert-butylperoxy)diisopropylbenzene (Luperco® 802), 2,5-dimethyl-2,5-di(tert-butylperoxy)-3-hexene, 2,5-dimethyl-2,5-di(tert-butylperoxy)-hexane, tert-butyl perbenzoate, tert-butyl perphenylacetate, tert-butyl per-sec-octoate, tert-butyl perpivalate, cumyl perpivalate, cumene hydroperoxide, diisopropyl benzene hydroperoxide, 1,3-bis(t-butylperoxy-isopropyl)benzene, dicumyl peroxide, tert-butylperoxy isopropyl carbonate and any combination thereof. Preferably, a dialkyl peroxides is employed in the process according to the present invention. More preferably, the peroxide is a,a′-bis-(tert-butylperoxy)diisopropylbenzene, 2,5-dimethyl-2,5-di(tert-butylperoxy)-hexane or 3,6,9-Triethyl-3,6,9-trimethyl-1,4,7-triperoxonane. Preferably, the peroxide is selected from the group of non-aromatic peroxides.

It can easily be determined by the person skilled in the art through routine experimentation how much peroxide should be used to obtain a composition having the desired melt flow rate. This also depends on the half-life of the peroxide and on the conditions used for the melt-mixing, which in turn depend on the exact composition.

Preferably, the propylene homopolymer matrix before any step of visbreaking has a pentad isotacticity of at least 96 wt. %, preferably of at least 97 wt %, wherein the pentad isotacticity is determined using ¹³C NMR and/or preferably, the propylene homopolymer matrix before any step of visbreaking has a melt flow rate (MFR_{Hopol}) as determined according to ISO1133-1:2011 using 2.16 kg at 230° C. in the range from 0.5 to 95, preferably 0.5 to 85, more preferably 5 to 85 dg/min.

Preferably, the propylene homopolymer matrix has a Cold Xylene Soluble content (CXS) of 1.0 to 4.0 wt %, preferably 1.0 to 3.0 wt %, measured by the method described in the section “CRYSTEX method for propylene homopolymer” of the Measurement methods section of the present application.

Preferably, the melt flow rate of the ethylene-propylene copolymer (MFR_{rubber}) is in the range from 0.03 to 3.0 dg/min, preferably in the range from 0.04 to 2.5 dg/min, for example in the range from 0.05 to 2.0 dg/min, wherein the MFR_{rubber} is calculated according to the following formula:

MFR_{rubber}=10\hat{ }((Log MFheterophasic-matrix content*Log MFR_{Hopol})/(rubber content))
wherein
MFRheterophasic is the MFR (dg/min) of the heterophasic propylene copolymer measured according to ISO1133-1:2011 (2.16 kg/230° C.),
MFR_{Hopol} is the MFR (dg/min) of the propylene homopolymer matrix measured according to ISO1133-1:2011 (2.16 kg/230° C.), matrix content is the fraction of the propylene homopolymer matrix in the heterophasic propylene copolymer,
rubber content is the fraction of the ethylene-propylene copolymer in the heterophasic propylene copolymer. For the avoidance of any doubt, Log in the formula means log 10.

Preferably, the propylene homopolymer matrix has a molecular weight distribution (Mw/Mn) in the range from 1.0 to 11.0, more preferably in the range from 4.0 to 9.0, wherein Mw stands for the weight average molecular weight and Mn stands for the number average weight and wherein Mw and Mn are measured according to ISO16014-1(4):2003.

### Process for the Preparation of the Heterophasic Propylene Copolymer

According to the invention, the heterophasic propylene copolymer is produced in a sequential multi-reactor polymerization process in the presence of a catalyst in a gas phase to obtain the heterophasic propylene copolymer.

The heterophasic propylene copolymer may be prepared by a process comprising
polymerizing propylene in the presence of a catalyst to obtain the propylene-based matrix and
subsequently polymerizing ethylene with α-olefins in the presence of a catalyst in the propylene-based matrix to obtain the heterophasic propylene copolymer. These steps are preferably performed in different reactors. The catalysts for the first step and for the second step may be different, but are preferably the same.

### Catalyst

The catalyst used for the preparation for the polypropylene composition according to the invention is the catalyst described in detail in WO2021/063930, incorporated herein by reference. The catalyst comprises a procatalyst, a co-catalyst and optionally an external electron donor.

The procatalyst is obtainable by a process comprising contacting a magnesium-containing support with a halogen-containing titanium compound, and an internal electron donor according to Formula I:

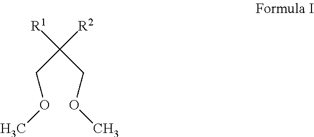

wherein R¹ is a secondary alkyl group and R² is a non-secondary alkyl group having at least 5 carbon atoms, preferably R² is a non-secondary alkyl group having at least 5 carbon atoms and being branched at the 3-position or further positions.

The process for providing said procatalyst comprises the steps of:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
iii) contacting the first or second intermediate reaction product, obtained respectively in step i) or ii), with a halogen-containing Ti-compound and said compound represented Formula I, as the internal electron donor.

In an embodiment, during step ii) as activating compounds an alcohol is used as activating electron donor and titanium tetraalkoxide is used as metal alkoxide compound.

In an embodiment, an activator is present. In an embodiment, said activator is ethyl benzoate. In an embodiment, said activator is a benzamide according to formula X:

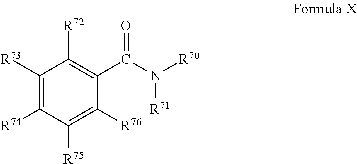

wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, preferably selected from alkyl, alkenyl, aryl, aralkyl, alkoxycarbonyl or alkylaryl groups, and one or more combinations thereof, more preferably wherein R⁷⁰ and R⁷¹ are both methyl and wherein R⁷², R⁷³, R⁷⁴, and R⁷⁵ are all hydrogen, being N,N′-dimethylbenzamide (Ba-2Me).

In some preferred embodiment the activating compound is N—N-dimethylbenzamide.

Preferably, the internal electron donors used are according to Formula I:

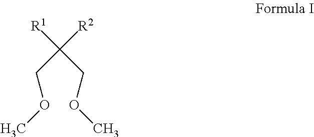

wherein R¹ is a secondary alkyl group having at least three carbon atoms (C3) and R² is a non-secondary alkyl group having at least 5 carbon atoms, preferably R¹ et R² is having at most seven carbon atoms (C7), preferably at most six carbon atoms (C6), preferably iso-propyl, iso-butyl, iso-pentyl, cyclopentyl, n-pentyl, and iso-hexyl, preferably R² is being branched at the 3-position or further positions

In another embodiment, the internal electron donor is 3,3-bis(methoxymethyl)-2,6-dimethyl heptane, according to Formula I wherein R¹ is iso-propyl being secondary alkyl and R² is iso-pentyl being non-secondary and having a branch on the third carbon atom (abbreviated as iPiPen, wherein iP stands for iso-propyl and iPen stands for iso-pentyl, also known as 3-methyl-butyl). This compound iPiPen has a chemical formula of C₁₃H₂₈O₂, an exact mass of 216.21 and a molecular weight of 216.37. In a more preferred embodiment of the invention, iPiPen is used as internal donor and N,N-dimethylbenzamide is preferably used as activator.

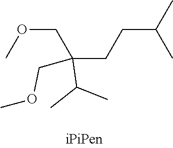

In another embodiment, the internal electron donor is (1-methoxy-2-(methoxymethyl)-5-methylhexan-2-yl)cyclopentane, according to Formula I wherein R¹ is secondary alkyl cyclopentyl and R² is secondary cyclopentyl (abbreviated as CPiPen, wherein CP stands for cyclopentyl and iPen stands for iso-pentyl, also known as 3-methyl-butyl). This compound CPiPen has a chemical formula of C₁₅H₃₀O₂; an exact mass of 242.22 and a molecular weight of 242.40. In a more specific embodiment, CPiPen is used as internal donor and N,N-dimethylbenzamide is preferably used as activator.

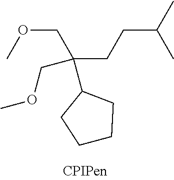 [SMILES: COCC(CCC(C)C)(COC)C1CCCC1]

In another embodiment, the internal electron donor is 3,3-bis(methoxymethyl)-2,7-dimethyloctane, according to Formula I wherein R¹ is the secondary alkyl iso-propyl and R² is non-secondary iso-hexyl with a branch on the four carbon atom (abbreviated as iPiHex, wherein iP stands for iso-propyl and iHex stands for iso-hexyl, also known as 4-methyl-pentyl). This compound iPiHex has a chemical formula of C₁₄H₃₀O₂; an exact mass of 230.22 and a molecular weight of 230.39. In a more specific embodiment, iPiHex is used as internal donor and N,N-dimethylbenzamide is preferably used as activator.

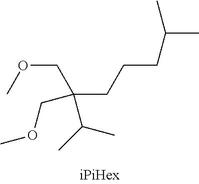 [SMILES: COCC(CCCC(C)C)(COC)C(C)C]

In another embodiment, the internal electron donor is 3,3-bis(methoxymethyl)-2-methyloctane, according to Formula I wherein R¹ is secondary alkyl iso-propyl and R² is non-secondary non-branched n-pentyl (abbreviated as iPnPen, wherein iP stands for iso-propyl and nPen stands for n-pentyl). This compound iPnPen has a chemical formula of C₁₃H₂₈O₂; an exact mass of 216.21 and a molecular weight of 216.37. In a more specific embodiment, iPnPen is used as internal donor and N,N-dimethylbenzamide is preferably used as activator.

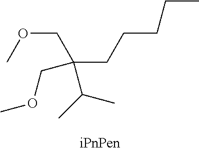

In another embodiment, the internal electron donor is 3,3-bis(methoxymethyl)-2,6-dimethyloctane, according to Formula I wherein R¹ is secondary alkyl iso-propyl and R² is non-secondary branched hexyl having a branch at the third carbon atom (abbreviated as iP3Hex, wherein iP stands for iso-propyl and wherein 3Hex stands for hexyl having a branch at the third carbon atom, also known as 3-methyl-pentyl). This compound iP3Hex has a chemical formula of C₁₄H₃₂O₂; an exact mass of 230.22 and a molecular weight of 230.39. In a more specific embodiment, iPiHex is used as internal donor and N,N-dimethylbenzamide is preferably used as activator.

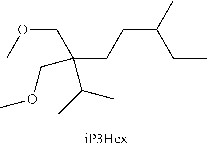 [SMILES: CCC(C)CCC(COC)(COC)C(C)C]

In an embodiment, the substituent R¹ is isopropyl or cyclopentyl. In an embodiment, the substituent R² is isopentyl or isohexyl. The below table shows the embodiments above with their abbreviations and the R¹ and R² groups as well if these groups are secondary or not and branched or not.

According to the present invention, it is further preferred that R¹ is a secondary alkyl group and R² is a non-secondary alkyl group being branched at the 3-position or further positions.

| | R¹ | | | R² | | |
|---|---|---|---|---|---|---|
| Abbrev | secondary | branched | # C | secondary | branched | # C |
| iPiPen | Yes (iP) | Yes at 1 | 3 | No (iPen) | Yes at 3 | 5 |
| CPiPen | Yes (CP) | Yes at 1 | 5 | No (iPen) | Yes at 3 | 5 |
| iPiHex | Yes (iP) | Yes at 1 | 3 | No (iHex) | Yes at 4 | 6 |
| iPnPen | Yes (iP) | Yes at 1 | 3 | No (nPen) | No | 5 |
| iP3Hex | Yes (iP) | Yes at 1 | 3 | No (3Hex) | Yes at 3 | 6 |

In some preferred embodiment, the co-catalyst is selected from the group consisting of trimethylaluminum, triethylaluminum, triisobutylaluminum, trihexylaluminum, di-isobutylaluminum hydride, trioctylaluminium, dihexylaluminum hydride and mixtures thereof.

Preferably, the external electron donors are chosen from the group of compounds having a structure according to:

(R⁹⁰)₂N—Si(OR⁹¹)₃, Formula III:

(R⁹²)Si(OR⁹³)₃, Formula IV:

Si(OR^{a})₄₋ₙR^{b}ₙ, Formula V: and
mixtures thereof,
wherein each of R⁹⁰, R⁹¹, R⁹² and R⁹³ groups are each independently a linear, branched or cyclic, substituted or unsubstituted alkyl having between 1 and 10 carbon atoms, preferably wherein R⁹⁰, R⁹¹, R⁹² and R⁹³ groups are each independently a linear unsubstituted alkyl having between 1 and 8 carbon atoms,
wherein n can be from 0 up to 2, and each of R^{a} and R^{b}, independently, represents an alkyl or aryl group, optionally containing one or more hetero atoms for instance O, N, S or P, with, for instance, 1-20 carbon atoms.

For example the external electron donors maybe ethyl, methyl or n-propyl, for example diethylaminotriethoxysilane (DEATES), n-propyl triethoxysilane, (nPTES), n-propyl trimethoxysilane (nPTMS), diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl) dimethoxysilane (DiPDMS). More preferably, the external electron donor is chosen from the group of di(iso-propyl) dimethoxysilane (DiPDMS) or diisobutyl dimethoxysilane (DiBDMS).

Preferably, the external donor comprises or consists of a compound selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof, preferentially di(iso-propyl) dimethoxysilane (DiPDMS)

The compounds mentioned above as examples of the external electron donor are sometimes referred as Selectivity Control Agent (SCA). The external electron donor may consist of SCA. Alternatively, in addition to SCA, the external electron donor may further comprise compounds known as an activity limiting agent (ALA). Preferably, the Activity Limiting Agent (ALA) is selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof. More preferably, the Activity Limiting Agent (ALA) is isopropyl myristate.

The ratio of Selectivity Control Agent (SCA) to Activity Limiting Agent (ALA) is in principle not critical, best results are obtained for a SCA/ALA ratio in the range from 0.010 to 100, more preferably in the range from 0.10 to 20.

The molar ratio of Al in the co-catalyst to Si in the external electron donor may e.g. be 1 to 120.

In a preferred embodiments, the molar ratio of Al in the co-catalyst to Si in the external electron donor is 1 to 25, preferably 1 to 15, preferably 3 to 10, more preferably 3.5 to 8. The relatively low molar ratio of Al/Si results in a higher stiffness of the composition. In some preferred embodiments, the molar ratio of Al in the co-catalyst to Si in the external electron donor is more than 15 and at most 120 or more than 25 and at most 120. The relatively high molar ratio of Al/Si results in a higher catalyst yield.

In some embodiment, the preferred molar ratio of Si in the external electron donor to Ti in the procatalyst is 10 to 50.

In some embodiment, the preferred molar r ratio of Al in the co-catalyst to Ti in the procatalyst is 125 to 250.

Catalyst yield (CY) Ti*Prod Rate/Mass HoldUp:

Preferably, the process has the process has CY Ti (KgPP/gcat)*Producion rate (Kg/h)/Mass Holdup (Kg) of at least 25, more preferably at least 30, more preferably at least 35, more preferably at least 40, wherein CY Ti (KgPP/gcat) is calculated following Equation (1):

$$CY Ti ( \frac{KgPP}{gcat} ) = \frac{Ti content in the catalyst 〈 \frac{g Ti}{g cat} )}{Ti content in 𝔱he polymer ( \frac{mg Ti}{Kg PP} )} * 1000 \qquad ( 1 )$$

wherein Ti content in the catalyst and Ti content in the obtained polymer is determined by Inductively coupled plasma mass spectrometry (ICP-MS).

### Composition

The polypropylene composition has a melt flow rate (MFR) in the range from 0.50 to 110 dg/min, wherein the melt flow rate is determined using ISO1133-1:2011 using 2.16 kg at 230° C. In some preferred embodiments, the MFR of the polypropylene composition determined using ISO1133-1:2011 using 2.16 kg at 230° C. is 0.50 to 30 dg/min. In some preferred embodiments, the MFR of the polypropylene composition determined using ISO1133-1:2011 using 2.16 kg at 230° C. is 30 to 110 dg/min.

Preferably, the amount of heterophasic propylene copolymer is at least 95 wt % based on the polypropylene composition.

### Inorganic Filler

The composition according to the invention may comprise an inorganic filler. Suitable examples of the inorganic filler include talc, calcium carbonate, wollastonite, barium sulphate, kaolin, glass flakes, laminar silicates (bentonite, montmorillonite, smectite) and mica. For example, the inorganic filler is chosen from the group of talc, calcium carbonate, wollastonite, mica and mixtures thereof. More preferably, the inorganic filler is talc.

Preferably, the inorganic filler has a median diameter d50 determined according to ISO13320-1:2020 of 5 to 20 μm, preferably 3 to 15 μm.

The composition according to the invention may be free of or substantially free of an inorganic filler. For example, the composition according to the invention may comprise less than 1.0 wt %, less than 0.1 wt % or less than 0.01 wt % of an inorganic filler.

### Additives

In some embodiments, the polypropylene composition further comprises additives, for example in an amount of 0.10 to 1.0 wt % based on the polypropylene composition.

Suitable additives include but are not limited to stabilizers. The stabilizer may e.g. be selected from heat stabilisers, anti-oxidants and/or UV stabilizers. Examples include common stabilizers such as Irgafos 168, Irganox 1010 and/or Irganox B225.

The additives may further include nucleating agents, colorants, like pigments and dyes; clarifiers; surface tension modifiers; lubricants; flame-retardants; mould-release agents; flow improving agents; plasticizers; anti-static agents; blowing agents; slip agents.

In one aspect, the invention provides an article comprising the polypropylene composition of the invention. Preferably, the amount of the polypropylene composition is at least 95 wt % based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention provides use of the polypropylene composition of the invention for the preparation of an article. Preferably, the amount of the polypropylene composition is at least 95 wt % based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention provides a process for the preparation of an article comprising the steps of:
a. providing the polypropylene composition of the invention and
b. converting the polypropylene composition into an article, for example by using an extrusion or injection molding process

It is further noted that the invention relates to all possible combinations of features described herein, including all possible combinations of embodiments described herein, preferred in particular are those combinations of features or embodiments that are present in the claims. It will therefore be appreciated that all combinations of features or embodiment relating to the composition according to the invention; all combinations of features or embodiments relating to the process according to the invention and all combinations of features or embodiments relating to the composition according to the invention and features or embodiments relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Process for Preparation of Procatalyst

For inventive examples E1 and E2: the procatalyst was prepared according to the method disclosed in WO2021/063930A1, example 1;

For comparative examples CE1 and CE2: the procatalyst is INcat P420 commercially available from INEOS Polyolefin Catalyst and prepared according to the instructions of the manufacturer.

### Process Conditions for Inventive Examples E1, E2, CE1 and CE2

Gas-phase polymerizations were performed in a set of two horizontal, cylindrical stirred bed, gas phase reactors in series to prepare the heterophasic propylene copolymers E1, E2, CE1 and CE2.

The homopolymer was formed in the first reactor (R1) and an ethylene-propylene copolymer rubber in the second one (R2) to prepare a heterophasic propylene copolymer. Both reactors were operated in a continuous way.

During operation, polypropylene powder produced in the first reactor was discharged through a powder discharge system into the second reactor.

The temperature of the powder bed is measured via a series of internal thermocouples. The data from these thermocouples is used to control the quench flow to the individual quench nozzles.

Hydrogen was fed independently to both reactors to control a melt flow index ratio over the homopolymer powder and copolymer powder. In this respect, RCC2 is the amount of ethylene incorporated in the rubber fraction (wt %) and RC is the amount of rubber incorporated in the heterophasic propylene copolymer (wt %) determined by 13C-NMR spectroscopy.

The propylene homopolymer from the first reactor was collected and its properties were measured. The heterophasic propylene copolymer from the second reactor and its properties were measured.

Table 1 shows the catalyst used in the polymerization process of the heterophasic propylene copolymer as well as various properties of the homopolymer obtained from the first reactor and various properties of the heterophasic propylene copolymer obtained from the second reactor.

TABLE 1
Reaction conditions of polymerization and polymer properties

| | E1 | E2 | CE3 | CE4 |
|---|---|---|---|---|
| Co-catalyst | TEA | TEA | TEA | TEA |
| External donor | DiPDMS | DiPDMS | DiPDMS | DiPDMS |
| Al/Ti (mol/mol) | 150 | 200 | 120 | 120 |
| Si/Ti (mol/mol) | 30 | 40 | 12 | 12 |
| Al/Si (mol/mol) | 5 | 5 | 10 | 10 |

Reactor 1

| | | | | |
|---|---|---|---|---|
| Temp (° C.) | 68 | 68 | 68 | 68 |
| Pressure (MPag) | 2.2 | 2.2 | 2.2 | 2.2 |
| H2/C3 (mol/mol) | 0.0450 | 0.0160 | 0.0407 | 0.0118 |

Properties of homopolymer from first reactor

| | | | | |
|---|---|---|---|---|
| MFRhopol (dg/min) | 67 | 12.3 | 71.7 | 12.2 |
| CXS hopol (wt %) | 1.8 | 1.2 | 2.4 | 1.5 |
| Pentad isotacticity (%) | 97.3 | 97.2 | 97.0 | 96.8 |
| Ti in powder (mg/kg) | 1.0 | 0.8 | 1.3 | 1.2 |
| CY Ti (kg PP/g cat)* | 29.9 | 39.9 | 19.6 | 18.8 |
| Prod Rate | | | | |
| (Kg/h)/Mass | | | | |
| HoldUp (Kg) | | | | |

Reactor 2

| | | | | |
|---|---|---|---|---|
| H2/C3 (mol/mol) | 0.0598 | — | 0.070 | 0.011 |
| C2/C3 (mol/mol) | 0.4770 | — | 0.490 | 0.360 |

Properties of heterophasic propylene copolymer

| | | | | |
|---|---|---|---|---|
| MFRcopol (dg/min) | 30.5 | — | 33.9 | 6.3 |
| RC (wt %) | 18.9 | — | 18.0 | 15.1 |
| RCC2 (wt %) | 53.4 | — | 53.7 | 48.7 |

Al/Ti is the molar ratio of the co-catalyst (TEA) to the procatalyst
Si/Ti is the molar ratio of the external donor (DiPDMS) to the procatalyst
Al/Si is the molar ratio of the co-catalyst (TEA) to the external donor (DiPDMS)
H2/C3 is the molar ratio of hydrogen to propylene

It can be seen that the process of E1-E2 made using the catalyst comprising the inventive procatalyst has a higher catalyst yield (indicated by CY Ti*Production rate/Mass Holdup) than CE1-CE2 made using a catalyst comprising a different procatalyst, while resulting in compositions having a comparable stiffness understood from the comparable values of the CXS and the isotacticity.

Surprisingly E1-E2 which uses a lower Al/Si molar ratio (higher amount of Si) in the catalyst than CE1-CE2 resulted in a higher catalyst yield than CE1. This shows the type of the procatalyst in the catalyst resulted in the difference in the catalyst yield.

Further, a lower amount of Ti was detected in E1-E2 than CE1-CE2.

### Measurement Methods

### MFR

The MFRₕₒₚₒₗ, MFRᵢₙᵢₜᵢₐₗ and MFR_{final} of the heterophasic propylene copolymer composition, the matrix phase and the dispersed phase measured according to ISO1133 using a 2.16 kg load at 230.

### RC, RCC2 and TC2

RC and RCC2 were determined by ¹³C-NMR spectroscopy. To this end, approximately 150 mg of material was dissolved in 1,1,2,2-tetrachloroethane-d2 (TCE-d2). To ensure a homogeneous solution, the sample preparation has been conducted in a heated rotary oven. The NMR measurements were carried out in the solution-state using a Bruker 500 Advance III HD spectrometer operating at 500.16 and 125.78 MHz for 1H and 13C, respectively, and equipped with a 10 mm DUAL cryogenically-cooled probe head operating at 125° C. The 13C-NMR experiments were performed using standard single pulse excitation utilizing the NOE and bi-level WALTZ16 decoupling scheme (Zhou Z. et al. J. Mag. Reson 187 (2007) 225. A total of 512 transients were acquired per spectrum. The spectra were calibrated by setting the central signal of TCE's triplet at 74.2 ppm. Quantitative 13C NMR spectra were processed, integrated and relevant quantitative properties determined from the integrals using proprietary computer programs. The total ethylene content (TC2) of the copolymer was calculated from the RC and RCC2.

### CRYSTEX Method

The CRYSTEX method described in WO2019179959 and herein below can determine the following properties of a heterophasic propylene copolymer:
amount of amorphous soluble fraction in the heterophasic propylene copolymer (CXS)
amount of amorphous soluble fraction in the propylene homopolymer matrix (CXS hopol).

The measurement of theses property may be performed according to CRYSTEX method by a CRYSTEX QC instrument of CRYSTEX QC Polymer Char (Valencia, Spain). A schematic representation of the CRYSTEX QC instrument is presented in Del Hierro, P.; Ortin, A.; Monrabal, B.; ‘Soluble Fraction Analysis in polypropylene, The Column’, February 2014. Pages 18-23.

The CRYSTEX QC instrument comprises an infrared detector (IR4) and an online 2-capillary viscometer. Quantification was done by the infrared detector which detects IR absorbance at two different bands (CH3 and CH2).

The machine was calibrated using using the Cold Xylene Soluble (CXS) and Cold Xylene Insoluble (CXI) fractions of various propylene polymers with known CXS content determined according to standard gravimetric method according to ISO16152.

### CRYSTEX Method for Heterophasic Propylene Copolymer

A sample of the heterophasic propylene copolymer to be analyzed is weighed in concentrations of 5 mg/mL. After automated filling of the vial with 1,2,4-TCB containing 250 mg/L 2,6-tert-butyl-4-methylphenol (BHT) as antioxidant, the sample is dissolved at 170° C. until complete dissolution is achieved, for 120 min, with constant stirring of 800 rpm.

### CRYSTEX Method for Propylene Homopolymer Matrix

A sample of the PP homopolymer (coming out of the 1^{st} reactor: propylene homopolymer matrix) to be analyzed is weighed in concentrations of 10 mg/mL. After automated filling of the vial with 1,2,4-TCB containing 250 mg/L 2,6-tert-butyl-4-methylphenol (BHT) as antioxidant, the sample is dissolved at 170° C. until complete dissolution is achieved, for 60 min, with constant stirring of 800 rpm.

### Isotacticity ¹³C NMR

175 mg of the polypropylene pellet was dissolved in 3 ml at 130° C. in deuterated tetrachloroethylene (C2D2C14) containing 2,6-Di-tert-butyl-4-methylphenol (BHT) (5 mg BHT in 200 ml C2D2CL). The ¹³C NMR spectrum was recorded on a Bruker Avance 500 spectrometer equipped with a cryogenically cooled probe head operating at 125° C.

The isotacticity of the mmmm pentad levels was determined from the ¹³C NMR spectrum in % based on the total pentad amount, respectively.

### Catalyst Yield (CY) Ti (KgPP/Gcat)*Production Rate (Kg/h)/Mass HoldUp (Kg)

Ti content in the catalyst and Ti content in the obtained polymer were measured by ICP. The ICP procedure is as follows: Approximately 250 mg of each sample are digested in 6 mL concentrated nitric acid (trace metal grade) by microwave assisted acid digestion using an Anton Paar Multiwave PRO equipped with closed high pressure Quartz digestion vessels. After the microwave digestion run, the acid is analytically transferred into a pre-cleaned plastic centrifuge tube containing 1 mL of internal standard solution and is diluted with MilliQ water up to the 50 mL mark. The elements in the sample are quantified using a multi-element calibration set from Inorganic Ventures using an Agilent 8900 ICP-MS system.

Then, CY is calculated following Equation (1)

$$CY Ti ( \frac{KgPP}{gcat} ) = \frac{Ti content in the catalyst 〈 \frac{g Ti}{g cat} )}{Ti content in 𝔱he polymer ( \frac{mg Ti}{Kg PP} )} * 1000 \qquad ( 1 )$$

Production Rate (Kg/h) and Mass HoldUp (Kg) are measured.
Production Rate (Kg/h)/Mass HoldUp (Kg) corresponds to the polymer residence time.

1. A process for the preparation of a polypropylene composition comprising a heterophasic propylene copolymer
wherein the heterophasic propylene copolymer consists of:
a propylene homopolymer matrix in an amount from 71 to 92 wt %, based on the heterophasic propylene copolymer and
an ethylene-propylene copolymer in an amount from 8 to 29 wt %, based on the heterophasic propylene copolymer,
wherein the amount of units derived from ethylene based on the ethylene-propylene copolymer is between 40 to 60 wt %, and
wherein the polypropylene composition has
a melt flow rate from 0.5 to 120 dg/min as determined according to ISO1133:2011 using 2.16 kg at 230° C.,
wherein the heterophasic propylene copolymer is produced in a sequential multi-reactor polymerization process in the presence of a catalyst in a gas phase to obtain the heterophasic propylene copolymer, wherein said catalyst comprises a procatalyst, a co-catalyst and optionally an external electron donor, wherein the procatalyst is obtainable by a process comprising the steps of:
contacting a magnesium-containing support with a halogen-containing titanium compound, and an internal electron donor according to Formula I: 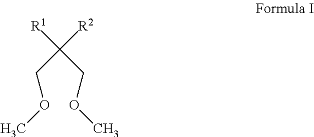
wherein R¹ is a secondary alkyl group and R² is a non-secondary alkyl group having at least 5 carbon atoms;
said procatalyst is prepared according to the following steps:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein X⁴ and X¹ are each independently selected from the group of consisting of fluoride (F—), chloride (Cl—), bromide (Br—) or iodide (I—); z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein w is smaller than v;
iii) contacting the first or second intermediate reaction product, obtained respectively in step i) or ii), with a halogen-containing Ti-compound and said compound represented Formula I, as the internal electron donor.

2. The process according to claim 1, wherein the co-catalyst is selected from the group consisting of trimethylaluminum, triethylaluminum, triisobutylaluminum, trihexylaluminum, di-isobutylaluminum hydride, trioctylaluminium, dihexylaluminum hydride and mixtures thereof.

3. The process according to claim 1, wherein, the catalyst comprises an external donor, wherein the external electron donor is a silane containing external donor,
and
the molar ratio of Al in the co-catalyst to Si in the external electron donor is 1 to 25.

4. The process according to claim 1, wherein during step ii) as activating compounds an alcohol is used as activating electron donor and titanium tetraalkoxide is used as metal alkoxide compound.

5. The process according to claim 1, wherein an activator is present.

6. The process according to claim 1, wherein the process has CY Ti (KgPP/gcat)*Producion rate (Kg/h)/Mass Holdup (Kg) of at least 25, wherein CY Ti (KgPP/gcat) is calculated following Equation (1):
$$CY Ti ( \frac{KgPP}{gcat} ) = \frac{Ti content in the catalyst 〈 \frac{g Ti}{g cat} )}{Ti content in 𝔱he polymer ( \frac{mg Ti}{Kg PP} )} * 1000 \qquad ( 1 )$$
wherein Ti content in the catalyst and Ti content in the obtained polymer is determined by Inductively coupled plasma mass spectrometry (ICP-MS).

7. The process according to claim 1, wherein the propylene homopolymer matrix has a Cold Xylene Soluble content (CXS) of 1.0 to 4.0 wt %, measured by the method described in the section “CRYSTEX method for propylene homopolymer” of the Measurement methods section of the description.

8. The process according to claim 1, wherein the heterophasic propylene copolymer within the polypropylene composition is prepared by visbreaking an intermediate heterophasic propylene copolymer having an initial melt flow rate (MFRinitial) from 0.5 to 50 dg/min, as determined according to ISO1133:2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 0.5 to 120 dg/min as determined according to ISO1133:2011 using 2.16 kg at 230° C. is obtained.

9. The process according to claim 1, wherein the polypropylene composition has a Cold Xylene Soluble content (CXS) in the range from 8 to 29 wt %, wherein the Cold Xylene Soluble content (CXS) is measured by the method described in the section “CRYSTEX method for heterophasic propylene copolymer” of the Measurement methods section of the description.

10. The process according to claim 1, wherein the propylene homopolymer matrix before any step of visbreaking has
a. a pentad isotacticity of at least 96 wt. %, wherein the pentad isotacticity is determined using ¹³C NMR and/or
b. a melt flow rate (MFR_{Hopol}) as determined according to ISO1133-1:2011 using 2.16 kg at 230° C. in the range from 0.5 to 95 dg/min.

11. The process according to claim 1, wherein the internal donor is 3,3-bis(methoxymethyl)-2,6-dimethylheptane, and/or wherein the activating compound is N—N-dimethylbenzamide.

12. The process according to claim 1, wherein the external donor comprises or consists of a compound selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof.

13. The process according to claim 1, wherein the external donor further comprises a compound selected from the group consisting of: ethyl acetate, ethyl benzoate, p-ethoxy ethyl benzoate, methyl trimethylacetate, isopropyl myristate, di-n-butyl sebacate, (poly)(alkylene glycol) mono- or diacetates, (poly)(alkylene glycol) mono- or di-myristates, (poly)(alkylene glycol) mono- or di-laurates, (poly)(alkylene glycol) mono- or di-dioleates, glyceryl tri(acetate), mixed glycerides of linoleic, oleic, palmitic and stearic acids, and mixtures thereof.

14. A polypropylene composition obtained by or obtainable by the process according to claim 1.

15. The polypropylene composition comprising a heterophasic propylene copolymer
wherein the heterophasic propylene copolymer consists of:
a propylene homopolymer matrix in an amount from 71 to 92 wt %, based on the heterophasic propylene copolymer and
an ethylene-propylene copolymer in an amount from 8 to 29 wt %, based on the heterophasic propylene copolymer,
wherein the amount of units derived from ethylene based on the ethylene-propylene copolymer is between 40 to 60 wt %, and
wherein the polypropylene composition has
a melt flow rate from 0.5 to 120 dg/min as determined according to ISO1133:2011 using 2.16 kg at 230° C.

16. An article comprising the polypropylene composition of claim 14,
wherein the amount of the polypropylene composition is at least 95 wt % based on the article and/or
wherein the article is prepared by injection molding and/or,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

17. A method of preparing an article comprising the polypropylene composition of claim 14,
wherein the amount of the polypropylene composition is at least 95 wt % based on the article and/or
wherein the article is prepared by injection molding and/or,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

18. A process for the preparation of an article comprising the steps of
a. providing the polypropylene composition of claim 14 and
b. converting the polypropylene composition into an article, for example by using an extrusion or injection molding process.
